(19) United States
(12) Patent Application Publication
(10) Pub. No.: US 2025/0217941 A1
(43) Pub. Date: Jul. 3, 2025

(54) SIGNAL DETECTION IN TENSOR DATA

(71) Applicant: Commissariat à l'Energie Atomique et aux Energies Alternatives, PARIS (FR)

(72) Inventors: Mohamed-Oumar OUERFELLI, GIF-SUR-YVETTE (FR); Mohamed TAMAAZOUSTI, GIF-SUR-YVETTE (FR); Parham RADPAY, GIF-SUR-YVETTE (FR); Vincent RIVASSEAU, VILLEBON-SUR-YVETTE (FR)

(21) Appl. No.: 19/002,961

(22) Filed: Dec. 27, 2024

(30) Foreign Application Priority Data
Dec. 28, 2023 (FR) 2315434

(51) Int. Cl. G06T 5/70

(52) U.S. Cl. CPC G06T 5/70; G06T 2207/20004; G06T 2207/20182

(57) ABSTRACT

The present description concerns a method of detecting a useful signal, the method comprising the acquisition of a raw signal, by a sensor; the delivery of the raw signal, to a processing device, the signal being represented by a tensor of order d greater than or equal to 3; the computing of an invariance value associated with the tensor, the invariance value being computed based on at least one trace invariant for tensors of order d; the comparison of the invariance value associated with the tensor with a first reference value; based on the comparison, the provision, by the processing device, of an estimate of the signal-to-noise ratio of the raw signal; and if the estimated signal-to-noise ratio is different from 0, the provision of the tensor to a circuit configured to process the raw signal.

### FIELD

The present disclosure generally concerns signal detection during the acquisition of tensor data, and in particular during the acquisition of image representations.

### BACKGROUND

Sensors, such as multi-sensors, configured to acquire data such as multi-channel images, videos, hyper-spectral images, etc. are subject to noise, of internal and/or external origin. The acquired data are then corrupted by noise, the amount of which is defined by a signal-to-noise ratio.

Signal detection methods exist when data are represented in the form of matrices, which is for example the case of gray-scale images. However, the application of these methods for data in the form of tensors of an order greater than or equal to 3 requires data reduction in order to convert them into matrices or vectors. This data reduction accordingly causes a loss of performance in signal detection.

It is desirable to improve signal detection methods for data represented in the form of a tensor of order greater than or equal to 3.

### SUMMARY

An embodiment provides a method of detecting a useful signal, the method comprising:
the acquisition of a raw signal, by a sensor;
the delivery of the raw signal, to a processing device, the raw signal being represented by a tensor of order d greater than or equal to 3;
the computing, by the processing device, of an invariance value associated with the tensor, the invariance value being computed based on at least one trace invariant under the orthogonal group of degree d for tensors of order d;
the comparison, by the processing device, of the invariance value associated with the tensor with a first reference value;
   based on the comparison, the provision, by the processing device, of an estimate of the signal-to-noise ratio of the raw signal; and
if the estimated signal-to-noise ratio is different from 0, the delivery of the tensor to a circuit configured to process the raw signal.

According to an embodiment, the sensor is configured to acquire representations of images and the circuit “configured to process the raw signal is an image processing circuit.

According to an embodiment, the invariance value associated with the tensor is a linear combination of a plurality of trace invariants Iⱼ for the orthogonal group for tensors of order d, the combination being in the form ΣⱼαⱼIⱼ, where values αⱼ are weighting coefficients.

According to an embodiment, the linear combination comprises melonic and/or “tadpole”-type and/or tetrahedral and/or “pillow”-type trace invariants.

According to an embodiment, the weighting coefficient of a “pillow”-type trace invariant is equal to the inverse of the variance of the invariant for a pure noise tensor.

According to an embodiment, the weighting coefficient of a melonic and/or “tadpole” and/or tetrahedral-type trace invariant is equal to the symmetrization weight of the invariant.

According to an embodiment, the first reference value is a function of the expectation of the invariance value for a pure noise tensor.

According to an embodiment, the first reference value is equal to E[I]+2\sqrt{Var(I)}, where E[I] and Var(I) respectively are the expectation and the variance of the invariance value for a pure noise tensor.

According to an embodiment, if the invariance value is greater than the first reference value, the processing device is configured to determine that the raw signal acquired by the sensor comprises a useful signal.

According to an embodiment, the above method further comprises, when it is determined that the invariance value is greater than the first reference value:
the comparison of the invariance value with a second reference value depending on the expectation of the invariance value for a tensor associated with a signal-to-noise ratio of value β.

An embodiment provides a device comprising:
a sensor configured to acquire a raw signal;
a processing device configured to execute instructions stored in a non-volatile memory of the device, the execution of the instructions enabling to detect whether the raw signal comprises a useful signal, by achieving:
the shaping of the raw signal in the form of a tensor of order greater than 3;
the computing of an invariance value of the tensor;
the comparison of the invariance value with a reference value;
based on the comparison, the estimation of the signal-to-noise ratio present in the raw signal; and
if it is determined that the signal-to-noise ratio is non-zero, the delivery of the tensor to a circuit configured to perform processing operations on the raw signal.

According to an embodiment, the sensor is configured to acquire image representations and the circuit configured to perform raw signal processing operations is an image processing circuit.

An embodiment provides a method of determining a combination of trace invariants, the combination being in the form ΣⱼαⱼIⱼ, where the Iⱼ are trace invariants and values αⱼ are weighting coefficients, adapted to a device, the method comprising:
the delivery of the indication of the memory resources of the device to an external device;
the delivery of the indication of a processing time, to the external device;
the delivery of an indication of dimensions of the order of the tensor to the external device;
the search for a set of trace invariants, in association with a set of weights, forming the combination, among a plurality of trace invariants, each set of trace invariants being associated with a cost and each cost value being stored in a memory of the external device in association with an identifier of the associated set, the search for the set of invariants being carried out on based on the memory resources and/or on the computing time and/or on the indication of the provided dimensions;
the delivery of the set of trace invariants and of the weights to the device so that an invariance value is computed, by the device, based on the determined combination of invariants.

According to an embodiment, the weights, associated with each trace invariant in each combination, are determined by the achieving of a gradient descent on an objective function determining a distance between the distribution of the invariance value associated with the combination for a pure noise tensor and for a tensor having a non-zero signal-to-noise ratio.

According to an embodiment, each trace invariant is a melonic and/or “tadpole”-type and/or tetrahedral and/or “pillow”-type trace invariant.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a block diagram showing a processing device;

FIG. 2 is an example of a tensor and of graphs showing trace invariants;

FIG. 3A and FIG. 3B illustrate graphs showing sets of trace invariants;

FIG. 4A and FIG. 4B illustrate analytical computings of moments of trace invariants associated with the pure noise tensor distribution;

FIG. 5 is a graph illustrating trace invariant distributions;

FIG. 6 is a flowchart illustrating steps of a method of signal detection, according to an embodiment of the present disclosure;

FIG. 7 is a flowchart illustrating steps of a method of signal detection, according to another embodiment of the present disclosure;

FIG. 8A and FIG. 8B illustrate the behavior of the numerator of an objective function for a plurality of invariants and a plurality of graphs;

FIG. 9A, FIG. 9B, FIG. 10A, and FIG. 10B are graphs illustrating the distribution of weights provided by a symmetrization method;

FIG. 11A and FIG. 11B are graphs illustrating gradient descents associated with the objective function;

FIG. 12A and FIG. 12B are graphs illustrating the values of the objective function for different graphs and as a function of the value of the signal-to-noise ratio;

FIG. 13A, FIG. 13B, FIG. 13C, and FIG. 13D are graphs illustrating trace invariant distributions;

FIG. 14A, FIG. 14B, and FIG. 14C are graphs illustrating success rates in signal detection, according to an embodiment of the present disclosure;

FIG. 15 is a graph illustrating weights obtained by gradient descent;

FIG. 16 is a flowchart illustrating a method of selecting a set of trace invariants, according to an embodiment of the present disclosure; and

FIG. 17 is a graph illustrating success rates in signal detection, according to an embodiment of the present disclosure and according to a matrix method.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

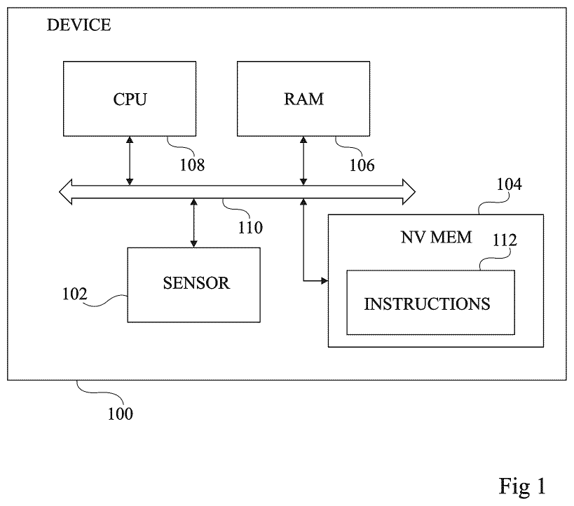

FIG. 1 is a block diagram showing a processing device 100 (DEVICE). Device 100 comprises one or a plurality of sensors 102 (SENSOR). As an example, sensor(s) 102 are multi-sensors configured to acquire image representations. In particular, the image representations acquired by sensor(s) 102 are data represented in the form of tensors of order greater than or equal to 3. The data are, for example, videos, images comprising at least two channels, such as for example color, infrared, etc. channels. An order-3 tensor representing a video can then be seen as a sequence of matrices, each matrix corresponding to an instant in the video. Each element of each matrix is then a grey-level value associated with a pixel of an image of the video at a given instant. Color images, or videos, are represented by higher-order tensors. For example, an RGB color image is represented by an order-3 tensor.

The image representations acquired by sensors such as sensor 102 are generally corrupted by noise. As an example, this noise comes from outside the device and/or is noise internal to sensor 102. Generally, the amount of noise in an image is assessed by a signal-to-noise ratio. A piece of data having a signal-to-noise ratio equal to 0 is pure noise data, that is, a piece of data only comprising noise. In particular, in the case where an image acquired by sensor 102 is pure noise data, this means that no signal has been measured during its acquisition. The higher the signal-to-noise ratio of a piece of data, the less the piece of data is corrupted by noise.

As an example, the noise present in the data acquired by sensor 102 is modeled by Gaussian noise. Thus, in the following, when reference is made to noise present in a tensor, this noise has the form of a tensor of same order and dimension and is formed of elements, each following a standard normal distribution, each element being independent of the others. This model is realistic, since noise sources are so diverse and numerous that the central limit theorem applies.

Device 100 further comprises a non-volatile memory 104 (NV MEM), a volatile memory 106 (RAM), and a processor 108 (CPU) coupled to sensor 102 via a bus 110. As an example, memory 106 is a random access memory (RAM) and processor 108 is a central processing unit (CPU). In another example, memory 106 is a video memory (VRAM-“Video Random Access Memory”), and processor 108 is a graphics processing unit (GPU). When sensor 102 acquires a piece of data, represented by a tensor, processor 108 is configured to execute instructions 112 (INSTRUCTIONS). As an example, instructions 112 are stored in non-volatile memory 104 and are loaded into volatile memory 106 to be executed. According to an embodiment, instructions 112 are instructions enabling to implement a method of signal detection in image representations, in the form of tensors of order greater than or equal to 3, acquired by sensor 102. In particular, the data manipulated during the implementation of the signal detection method are not converted in the form of matrices, or more broadly, in the form of tensors of order lower than 3.

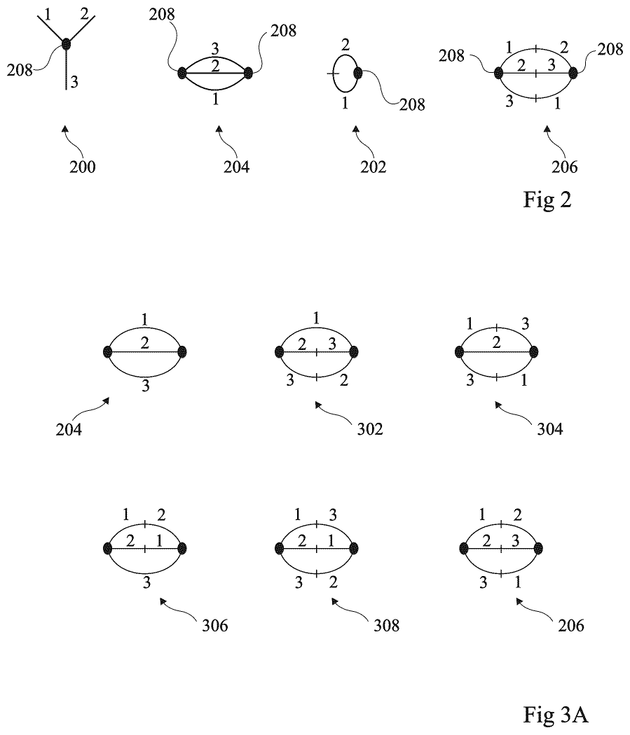

FIG. 2 is an example of graphs representing trace invariants. For a tensor T, Einstein's notation will be used for summations. In other words, for an order-3 tensor T, quantity T_{i,j,k}T_{i,j,k} is the sum of all the tensor elements, that is, T_{i,j,k}T_{i,j,k}=Σ_{i,j,k} T[i][j][k]. Generally, an invariant value for a tensor T∈⊗ᵢ₌₁^{d}Rⁿ^{ᵢ} is a scalar invariant under transformations such as Tᵢ_{₁} _{. . . i}_{_{d}}→T′ᵢ_{₁}_{. . . i}_{ₖ}=Σⱼ_{₁} _{. . . j}_{_{d}} Oᵢ_{₁}ⱼ_{₁}⁽¹⁾ . . . Oᵢ_{_{d}}ⱼ_{_{d}}^{(d)}Tⱼ_{₁} _{. . . j}_{_{d}}, where elements Oᵢ_{₁}ⱼ_{₁}⁽¹⁾ . . . Oᵢ_{_{d}}ⱼ_{_{d}}^{(d)} are elements of orthogonal groups O(n₁)× . . . ×O(n_{d}). In the case of a matrix M, values such as the trace of product MM′, where M′ is the transpose of matrix M, its determinant, or also the coefficients of its characteristic polynomial are invariant values.

Trace invariants are generally formed by contraction of one or a plurality of copies of a tensor. The number of copies determines the degree of the invariant. Thus, the trace of a matrix is an order-1 invariant. In particular, trace invariants admit representations in the form of graphs.

Graphs 200 and 202 illustrate examples of order-1 trace invariants. Graphs 204 and 206 illustrate examples of order-2 trace invariants.

Copies of tensors are represented by vertices 208 for order-3 tensors and vertices 210 for a matrix. Each edge, numbered 1, 2, or 3 in FIG. 2, corresponds to an index of the tensor. Thus, the number of edges corresponds to the order of the tensor.

Graph 200 represents a copy of an order-3 tensor. In particular, the copy represented by graph 200 is a copy T_{i,j,k} of a tensor T. The edges numbered 1, 2, and 3 respectively represent indices i, j, and k.

Graph 202 shows the trace of a matrix. The two edges 1 and 2 meet, which means that the sum is performed on the diagonal elements of the matrix. Thus, the trace of a matrix is equal to T_{i,i}.

Graphs 204 and 206 represent order-2 trace invariants for order-3 tensors. In particular, graph 204 represents the contraction of two copies 208 and the shown invariant is T_{i,j,k}T_{i,j,k}. Graph 206 illustrates a contraction of two copies 208, the contraction taking place on indices having different positions. The junction of the two edges at the top means that the sum is performed on the first copy having its first index equal to the second index of the second copy. The shown trace invariant then is T_{i,j,k}T_{k,i,j}.

In the context of graph representation, a tensor symmetrization method consists of summing all possible edge permutations, the sum being weighted by the inverse of the number of possible permutations. Thus, in the example of graph 200, and when tensor T is a cubic order-3 tensor, each element T̅[i][j][k] of the symmetrized tensor T̅ is equal to (T[i][j][k]+T[i][k][j]+T[i][i][k]+T[j][k][i]+T[k][i][j]+T[k][j][i])/6.

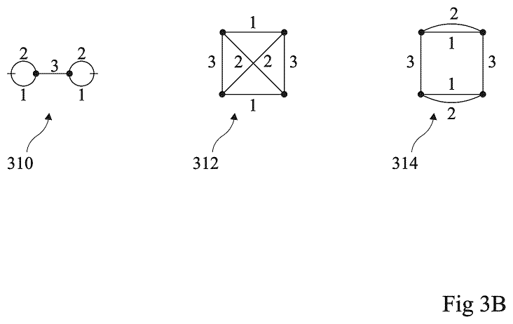

FIGS. 3A and 3B show graphs representing sets of trace invariants.

In particular, FIG. 3A shows melonic graphs for order-3 tensors. The graphs of this category are formed by self-contraction of two tensor copies. In the case of order-3 tensors, this category comprises 36 graphs, and comprises in particular graphs 204, noted I₁, and 206, noted I₆. By setting the order of the indices of the first copy to {i, j, k}, the number of graphs is reduced to 6. Indeed, trace invariants T_{i,j,k}T_{i,j,k} and T_{j,k,i}T_{k,i,j} are identical, T_{i,j,k} can thus be considered as the first copy. By defining a category of graphs as being a set of graphs, each graph of which corresponds to the other graphs in the set to within an index permutation, the other four graphs in the melonic category are graphs 302, 304, 306, and 308, respectively representing trace invariants I₂=T_{i,j,k}T_{i,k,j}, I₃=T_{i,j,k}T_{k,j,i}, I₄=T_{i,j,k}T_{j,i,k}, and I₅=T_{i,j,k}T_{j,k,i}. However, the shown invariants I₅ and I₆ are identical. This means that there are only five possible melonic graphs that can be formed, and the contraction of symmetrized tensors gives different weights to these invariants. In order to avoid symmetrizing the tensors, as described in relation with FIG. 2, which is costly in terms of time and resources, symmetrization weights are assigned to each invariant. In particular, the weights of the 5 possible trace invariants are {1,1,1,1,2}.

FIG. 3B shows graphs 310, 312, 314, each belonging to other graph categories.

Graph 310 is an example of a so-called “tadpole” graph. The invariant represented by graph 310 is equal to T_{j,j,k}T_{i,i,k}. Each graph in the “tadpole” category has its vertices coupled by a central edge corresponding to a single index, and the other two edges of each copy meet. The “tadpole” category comprises 6 different graphs, and the symmetrization weights are {1,1,1,2,2,2}. The 6 invariants represented by tadpole graphs are I′₁=T_{j,j,k}T_{i,i,k}, I′₂=T_{i,j,i}T_{k,j,k}, I′₃=T_{i,j,j}T_{i,k,k}, I′₄=T_{i,j,i}T_{k,k,j}, I′₅=T_{i,j,j}T_{k,k,i}, and I′₆=T_{i,j,i}T_{k,i,j}.

Graph 312 is an example of a tetrahedral graph. Tetrahedral graphs represent trace invariants involving 4 copies of a tensor. The trace invariants represented by these graphs are accordingly order-4 trace invariants. The invariant represented by graph 312 is equal to T_{i,j,k}T_{i,j′, k′}T_{i′, j,k′}T_{i′,j′k}. The tetrahedral graphs represent 60 different trace invariants, among the 216 invariants without taking symmetries into account, with weights varying between the values {1,2,4}.

Graph 314 is an example of a so-called “pillow” graph, formed by double contraction between two pairs of tensor copies. The trace invariants represented by pillow graphs are order-4 trace invariants. In particular, graph 314 represents an invariant equal to T_{i,j,k}T_{i,j′,k′}T_{i′,j,k′}T_{i′j′k}. Pillow graphs represent 99 different trace invariants, from among 348, with weights varying between the values {1,2,4}.

FIGS. 3A and 3B show examples of graphs for order-3 tensors, but there of course exist graph representations for tensors of orders higher than 3. The number of trace invariants per category is then higher.

According to an embodiment, instructions 112 enable to compute an invariance value by calculating a trace invariant, or of a combination of trace invariants, represented by a single, or a plurality of, graph categories. Instructions 212 are further configured so that the invariance value is compared with the invariance values distribution for pure noise tensors. In particular, the invariance value is compared with a value based on the expectation of the invariance value for a tensor formed of pure noise only. In another example, the invariance value is compared with a value based on the expectation and the variance of the invariance value for a tensor formed of pure noise only. Such a tensor can then be written as T=Z where Z is, for example, a Gaussian tensor, each element of which is independent of the others and follows a standard normal distribution. In another example, tensor Z is a tensor modeling a noise having its elements, for example, correlated and/or following a distribution different from a Gaussian distribution.

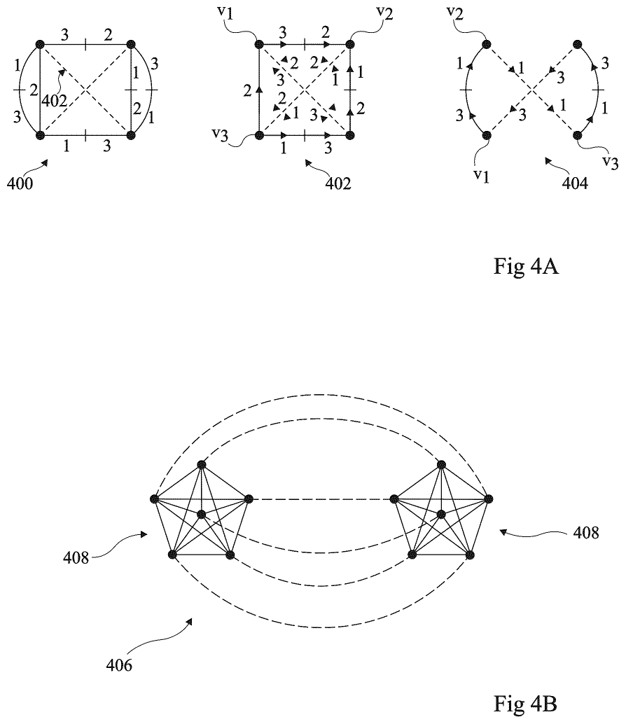

FIGS. 4A and 4B illustrate analytical computings of trace invariant moments associated with the pure noise tensor distribution.

In particular, FIG. 4A shows an example of an expectation computing for a “pillow”-type trace invariant for a pure noise order-3 tensor. The computing of expectations, and more generally of moments of any order, is based on a representation of the graph associated with the trace invariant in a spanning graph. A spanning graph 400 is an example of a spanning graph for so-called “pillow” graphs. A spanning graph for an invariant of order k, of a tensor of order d, is constructed by adding half-edges 402, called propagators and shown in dotted lines, to each vertex and by then connecting each propagator to another. For a given graph, there thus exist a plurality of spanning graphs.

The computing of the expectation of an invariant represented by a graph is based on the recognition of cycles in the spanning graph. Starting from a first vertex v₁, an edge, made up of two indexed half-edges, is followed up to a second vertex v₂, after which the propagator coupling vertex v₂ to a vertex v₃ is followed. From vertex v₃ the half-edge starting from vertex v₃ being of the same index as the half-edge preceding vertex v₂ is followed. The reading of the graph continues in this way until it is returned to the first edge which has been followed, that is, the edge running from vertex v₁ to vertex v₂. Spanning graph 400 thus comprises two cycles 402 and 404.

FIG. 4B shows a spanning graph 406 linking two identical graphs 408 representing an invariant of order 6 of a tensor of order 5. This type of spanning graph, between two copies of graphs, is used to compute the moment of order 2 of the invariant. Generally, to compute a moment of order m, m≥1, the number of cycles, in a spanning graph, between a number m of copies of the graph representing the invariant in question will be counted.

Each cycle of the spanning graph then contributes by a factor n to the value of the moment, where n is the dimension of the tensor. Thus, the value of a moment of order m, for an invariant T and represented by a graph G, is given by the equation:

$$E [ {I}_{G} ( T ) ] = {\sum }_{{G}^{′}} {n}^{\# \{ nb cycles \}} , \qquad [ Math 1 ]$$

where the sum is performed on all the spanning graphs G′ of graph G, and value {nb cycle} corresponds to the number of cycles on each spanning graph. This relation is verified in the Gaussian case, but has a universal aspect. Indeed, this relation is also verified for other noise distributions. The universality of this relation is, for example, discussed in “Universality for Random Tensors” published in the Annales de l'I.H.P. Probabilités et statistiques by Gurau, R. in 2014.

In the case of tensors of dimensions n₁× . . . ×n_{d}, the computing of moments is generalized. In an example, in this case, only the invariants associated with graphs having a single index on each edge are used in trace invariant computing. In another example, a matrix A is constructed from the initial tensor T. For example, for an order-3 tensor T, of dimension n₁×n₂×n₃, matrix A is a square matrix of dimension n₁×n₁ and each component A_{i,l} of this matrix is equal to the sum Σ_{≤j≤n}_{₂}_{1≤k≤n}_{₃} T[i][j][k]T[l][k][j].

The following tables gather the values of expectation, variance, as well as the symmetrization weights for melonic and “tadpole” graphs. In particular, Table 1 gathers melonic graphs and Table 2 gathers “tadpole” graphs.

TABLE 1

| | Sub-category 1 | Sub-category 2 | Sub-category 3 |
|---|---|---|---|
| Invariants | I₁ | I₂, I₃, I₄ | I₅ = I₆ |
| Expectation | n³ | n² | n |
| Variance | 2n³ | 2n³ | n³ + n |
| Weight | 1 | 1 | 2 |

TABLE 2

| | Sub-category 1 | Sub-category 2 |
|---|---|---|
| Invariants | I′₁, I′₂, I′₃, | I′₄, I′₅, I′₆ |
| Expectation | n² | n |
| Variance | 2n³ | n³ + n |
| Weight | 1 | 2 |

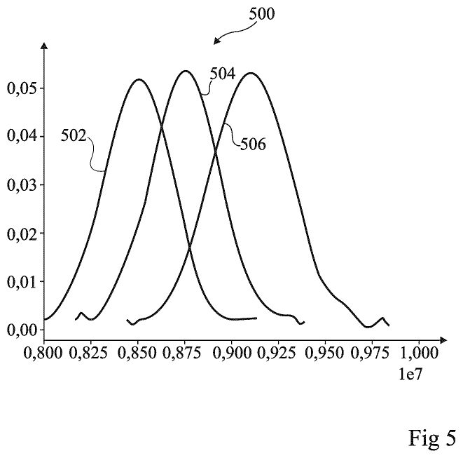

FIG. 5 is a graph 500 illustrating trace invariant distributions. In particular, FIG. 5 illustrates trace invariant distributions for tensors comprising a useful signal, that is, having a signal-to-noise ratio strictly greater than 0.

In order to compute the moments of an invariant for tensors having a signal-to-noise ratio strictly greater than 0, each vertex of the associated graph is written in the form:

$${T}_{{i}_{1} , … , {i}_{k}} = \sqrt{n} β {v}_{{i}_{1}} … {v}_{{i}_{k}} + {Z}_{{i}_{1} , … , {i}_{k}} , \qquad [ Math 2 ]$$

where part vᵢ_{₁} . . . . nᵢ_{ₖ} represents the signal and where Z is a pure noise tensor of the same dimensions and order as tensor T. The computing of the expectation of a trace invariant is performed by using the same cycle counting method as described in relation with FIGS. 4A and 4B. However, when, in a cycle, there is an odd number of elements of tensor Z, that is, if the number of vertices crossed during the cycle is odd, the expectation and, more generally, every moment of odd order is zero for this cycle.

Graph 500 shows distributions of a “pillow”-type trace invariance value.

A curve 502 illustrates the distribution of “pillow”-type trace invariance values for a pure noise tensor. Curves 504 and 506 respectively illustrate the distributions of these same invariance values when signal-to-noise ratio β is equal to 1.6 and 2.6. Distributions 504 and 506 then correspond to distribution 502 shifted by a value, depending on the signal-to-noise ratio.

In the case of “tadpole”, tetrahedral, or melonic graphs, the trace invariance values distributions have the same shape, and a shift depending on the value of the signal-to-noise ratio can be observed.

In the rest of the disclosure and unless otherwise specified, a moment, in particular the expectation, or the variance of a trace invariant, corresponds to the moment, in particular to the expectation, or to the variance, of the invariant for a pure noise tensor.

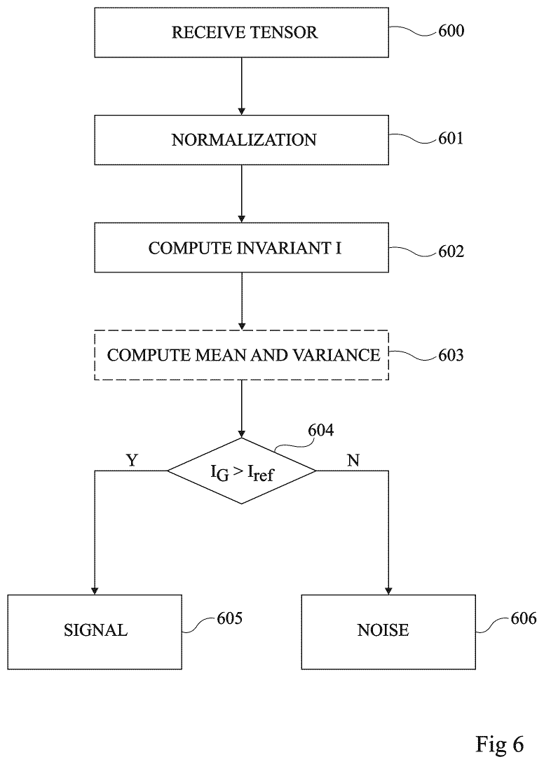

FIG. 6 is a flowchart illustrating steps of a signal detection method, according to an embodiment of the present disclosure.

At a step 600 (RECEIVE TENSOR), a tensor is supplied to processor 108. As an example, the tensor is a digital object, obtained by conversion of analog data measured by sensor 102. As an example, after the reception of the tensor, processor 108 is configured to symmetrize it.

At a step 601 (NORMALIZATION), the variance of the tensor components is computed. The tensor is then normalized based on the computed variance.

At a step 602 (COMPUTE INVARIANT I), an invariance value I for the symmetrized tensor is computed by processor 108. As an example, the invariance value corresponds to an trace invariant I_{G}, represented by a graph G. In another example, the invariance value is a linear combination of a plurality of trace invariants I=τⱼαⱼI_{G}_{ⱼ}, where each I_{G}_{ⱼ} is a trace invariant represented by a graph Gⱼ. Graphs Gⱼ belong to one or a plurality of categories of graphs. Each coefficient αⱼ is associated with graph G; and has, for example, been computed upstream. As an example, at least one of coefficients αⱼ is equal to the symmetrization weight associated with graph Gⱼ. As an example, at least one of coefficients αⱼ is equal to the inverse of the variance of invariant Iⱼ.

At a step 603 (COMPUTE MEAN AND VARIANCE), the expectation and the variance of the invariance value for a pure noise tensor are computed. The computed expectation and variance correspond to the expectation E[I] and/or the variance Var[I] of the trace invariant, or of the combination of trace invariants considered at step 601. In the case where a single invariant is considered, expectation E[I] is equal to E[I_{G}] and variance Var(I) to Var(I_{G}). In the case where the invariant is a combination of a plurality of invariants/=τⱼαⱼI_{G}_{ⱼ}, expectation E[I] is equal to Σⱼαⱼ E[I_{G}_{ⱼ}]. The variance is obtained by development of the variance of a linear combination. As an example, step 602 is carried out upstream, for example during the programming of instructions 112. The values of expectation E[I] and of variance Var[I] are then for example stored in non-volatile memory 104. In another example, the expectation E[I] and variance Var[I] are computed on the fly at each execution of instructions 112.

At a step 604 (I<I_{ref}), processor 108 is configured to, by executing instructions 112, compare the invariance value with a reference value. As an example, reference value is equal to value E[I]+2Var(I). As an example, the reference value is included in memory 104. In other examples, the reference value is another value, representing the invariance value distribution for the considered invariant or combination of invariants. In another example, the reference value is equal to expectation E[I]. Still in another example, the reference value is equal to E[I]+3 Var(I).

In the case where the invariance value is greater, for example strictly greater, than the reference value (branch Y at the output of block 604), processor 108 is configured to determine, at a step 605 (SIGNAL), that the tensor comprises a useful signal, that is, that signal-to-noise ratio β is strictly greater than 0. In the case where the invariance value is lower than the reference value (branch N at the output of block 604), processor 108 is configured to determine, at a step 606 (NOISE), that the tensor is a pure noise tensor, that is, that signal-to-noise ratio β is equal to 0.

As an example, when processor 108 determines that the tensor is a pure noise tensor, the latter is removed from device 100. On the contrary, when processor 108 determines that the tensor comprises a useful signal, the tensor is, for example, delivered to a data processing circuit. As an example, the data processing circuit is configured to perform denoising operations on the tensor. In particular, when the tensor is an image representation, such as a color image, or a video, the data processing circuit is configured to perform image processing operations.

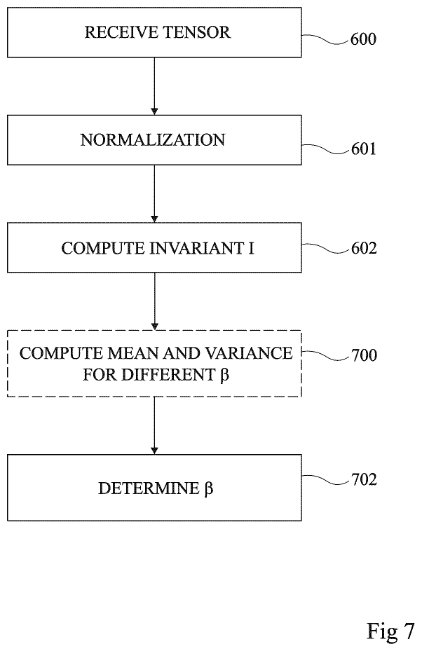

FIG. 7 is a flowchart illustrating steps of another signal detection method.

As an example, the method described in relation with FIG. 7 comprises steps 600 to 602 described in relation with FIG. 6.

At a step 700 (COMPUTE MEAN AND VARIANCE FOR DIFFERENT B), a value of expectation E_{β}[I] and of variance Var_{β}(I) of an invariance value of a tensor having a signal-to-noise ratio β are computed. As an example, step 700 is carried out for a plurality of values of β, where β may for example, be zero. These values are computed upstream, for example during the programming of instructions 112. In another example, these values are computed on the fly, during the execution by processor 108 of instructions 112.

At a step 702 (DETERMINE B), processor 108 is configured to determine the value of the signal-to-noise ratio of the tensor received at step 600. AS an example, invariance value I is compared with the different expectations E_{β}[I] computed during step 700. The retained signal-to-noise ratio is the value of β minimizing value |I−E_{β}[I]|. In other examples, invariance value/is compared with the different values E_{β}[I]+2Var_{β}(I). The retained signal-to-noise ratio is the value of β minimizing value |1−E_{β}[I]+2\sqrt{Var_{β}(I)}|.

As an example, when it is determined that the signal-to-noise ratio is different from 0, the tensor is supplied to a data processing circuit, for example configured to perform image processing operations, in association with the estimated value of the signal-to-noise ratio.

However, as shown in FIG. 5, the distributions of a trace invariant according to different values of β overlap. This induces an uncertainty in the signal detection result. Indeed, during the carrying out of the methods described in relation with FIGS. 6 and 7 based on the invariant used for FIG. 5, there exists a risk for a tensor comprising a useful signal to be determined as being a pure noise tensor, or conversely.

According to an embodiment, the invariance value is computed based on a combination of at least one trace invariant for which the overlap interval between distributions is reduced.

For an invariance value I, a distance between the distributions associated with a pure noise tensor and a tensor comprising a useful signal with a signal-to-noise ratio β is represented by an objective function:

$${f}_{β} ( I ) = \frac{{m}_{S} ( I , β ) - {m}_{N} ( I )}{{σ}_{N} ( I ) - {σ}_{S} ( I , β )} , \qquad [ Math 3 ]$$

where m_{S}(1, β) and σ_{S}(I, β) respectively are the expectation and the standard deviation of the distribution of an invariant, or combination of invariants, for a tensor having a signal-to-noise ratio equal to β and where m_{N}(I) and σ_{N}(I) are the expectation and the standard deviation of the distribution of the same invariant, or same combination of invariants, for a pure noise tensor. The idea is then to look for an invariance value in the form of a combination I=ΣⱼαⱼI_{G}_{ⱼ} for which quantity ƒ_{β}(I) is sufficiently large to avoid detection errors.

The parameter space then describing invariant I is t-simplex Δ^{t}, where t is the number of invariants I_{G}_{ⱼ} considered in the combination. Thus, when looking at the numerator of the objective function applied to a weighted invariant, it can be observed that for at least the order-2 trace invariants, the numerator of ƒ_{β}(αⱼI_{G}_{ⱼ}) is independent of the type of selected invariant and, due to the contribution of order \sqrt{n}β for each vertex, is in the order of nβ². Thus, when summing invariants of order 2, it is sufficient to take into account the contribution of the signal in nβ² in the numerator and to multiply it with the sum of the weights τⱼαⱼ in the numerator.

In the case of invariants of degree 4, the numerator is more complex and has the form P_{I}(n)nβ²+n²β⁴. For certain graphs, such as tetrahedral graphs, and certain “pillow” graphs, value P_{I}(n) is lower than nβ² when dimension n is sufficiently large. Thus, contribution n²β⁴ factorizes in the numerator. Looking at the denominator, and more particularly σ_{S}(I, β), the largest contribution can be approximated by 2σ_{N}(I). These approximations show that for invariants of order 2, or of order 4 satisfying condition P_{I}(n)<n²β⁴, quantity σ_{N}(ΣⱼαⱼI_{G}_{ⱼ})/Σⱼαⱼ admits a minimum. Further, under the condition that Cov(I_{G}_{ⱼ}, I_{G}_{ᵢ}) is negligible as compared with Var(I_{G}_{ⱼ}) and Var(I_{G}_{ᵢ}), this quantity is minimum when weights αⱼ are equal to N/Var(I_{G}_{ⱼ}) where N is a normalization constant such that N Σⱼαⱼ=1.

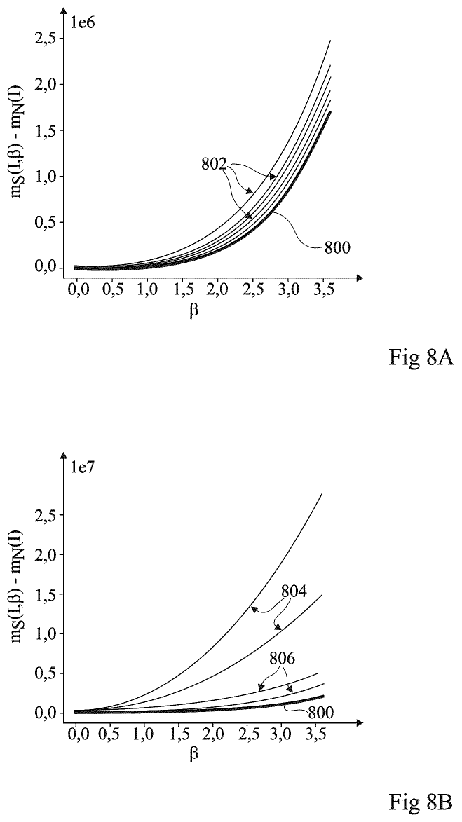

FIGS. 8A and 8B are graphs illustrating the behavior of the objective function. In particular, FIGS. 8A and 8B illustrate the behavior of the numerator of the objective function for a plurality of invariants and a plurality of graphs.

A curve 800 is the curve of equation n²β⁴ as a function of β. FIG. 8A shows a plurality of curves 802, each illustrating the behavior of m_{S}(I, β)−m_{N}(I), as a function of β and for a plurality of tetrahedral-type invariants. FIG. 8B shows a plurality of curves 804, and 806, each illustrating the behavior of m_{S}(I, β)−m_{N}(I) as a function of β and for a “pillow”-type invariant. The two FIGS. 8A and 8B both show a discrepancy between the behavior of the invariants and of n²β⁴. This discrepancy is due to the previously-described terms P_{I}. However, in the case of tetrahedral graphs, the discrepancy between curves 802 and 800 is small. The influence of term P_{I} then is negligible when the dimension n of the tensor is large, for example when n≥100. On the other hand, in the case of “pillow” graphs, the discrepancy between curves 804 and 800 shows that the term P_{I} is not negligible for these invariants. The discrepancy between curves 806 and 800 is however small, there thus exist “pillow” graphs for which the term P_{I} is negligible.

In particular, when the term P_{I} is negligible when n is large, the objective function is such that

$${f}_{β} ( I ) = \frac{{m}_{S} ( I , β ) - {m}_{N} ( I )}{{σ}_{N} ( I ) - {σ}_{S} ( I , β )} ∼ \frac{{( n {β}^{2} )}^{s / 2} {\sum }_{j} {α}_{j}}{2 {σ}_{N} ( I )} , \qquad [ Math 4 ]$$

where s corresponds to the order of the invariants. In the case where the invariance value is computed from invariants of different orders, the value of s is an approximation. For example, the value of s corresponds to the average of the orders of the trace invariants used. The minimization of the objective function consists in searching for a combination of values for each αᵢ, under the condition that Σαᵢ=1 and so that, for this combination of coefficients, the value of the objective function is as low as possible.

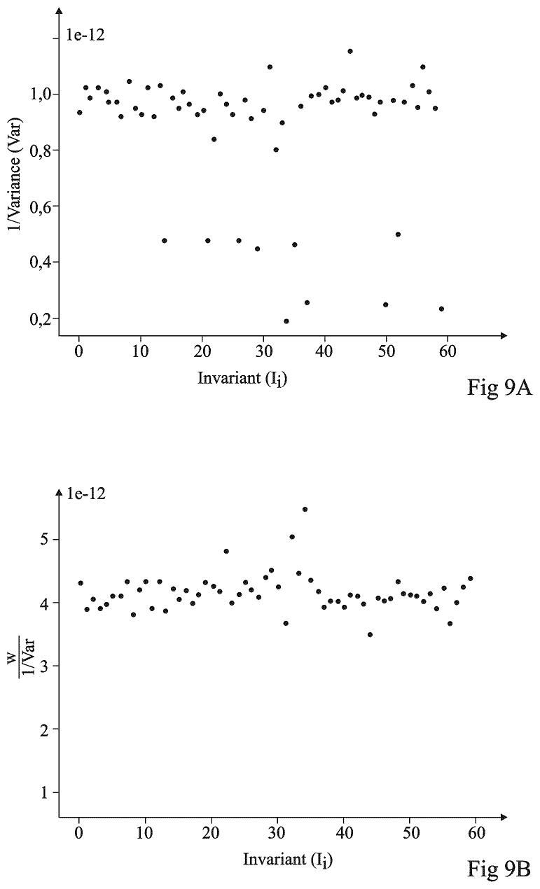

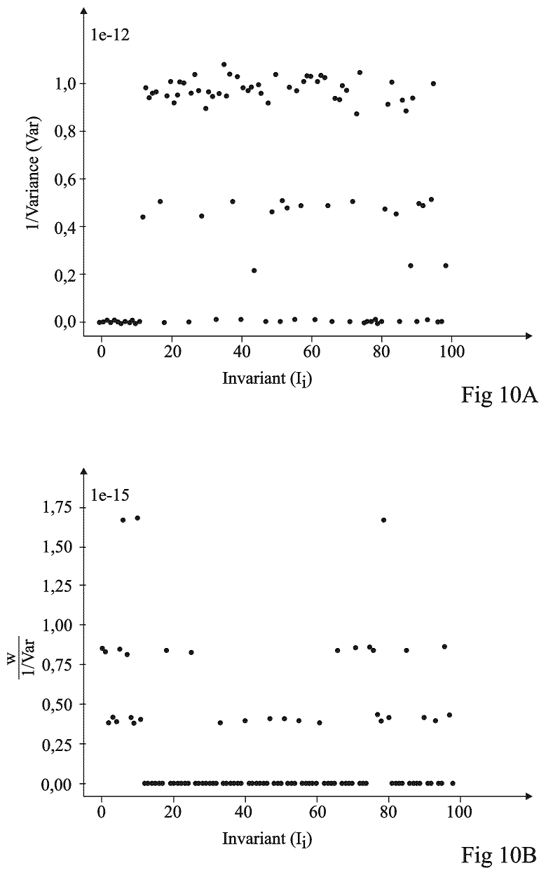

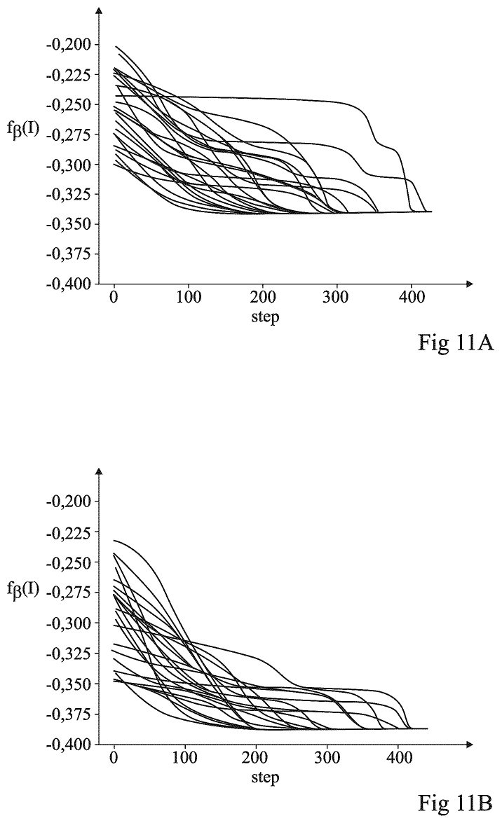

FIGS. 9A, 9B, 10A, and 10B are graphs illustrating the distribution of weights supplied by a symmetrization process.

In particular, FIGS. 9A and 9B show weights for the 60 different tetrahedral graphs Gᵢ. FIGS. 10A and 10B show weights for the 99 different “pillow” graphs Gᵢ.

FIGS. 9A and 10A are graphs respectively comprising 60 and 99 points. Each point has as an abscissa the index i of the considered graph and as an ordinate the associated value of 1/Var(I_{G}_{ᵢ}).

FIGS. 9B and 10B are graphs respectively comprising 60 and 99 points. Each point has as an abscissa (Invariant(Iᵢ) the index i of the considered graph, and as an ordinate the associated value of wᵢ/Var(I_{G}_{ᵢ}), where wᵢ is the symmetrization weight of invariant Iⱼ.

FIGS. 9A and 9B show that, in the case of tetrahedral graphs, the weights wᵢ produced by the symmetrization and the values 1/Var(I_{G}_{ᵢ}) are proportional. In this case, the symmetrization is equivalent to the weighting of the graphs by the inverse of the variance. Conversely, FIGS. 10A and 10B show that, in the case of “pillow” graphs, symmetrization weights wᵢ and 1/Var(I_{G}_{ᵢ}) are not proportional.

The weight values used for FIGS. 9B and 10B are, for example, obtained by means of numerical methods enabling to count the number of repetitions in the 216, or 348, possible invariants for tetrahedral, or “pillow”, graphs. For each invariant, the variance is, for example, obtained numerically, for example, from a large number of samples, for example between 500 and 2,000, of pure noise tensors. As an example, the numerical computing of the variance is performed upstream of the signal detection method such as described in relation with FIGS. 6 and/or 7. As an example, the numerical computing of the variance is performed on a computer, prior to the programming of instructions 112.

FIGS. 11A and 11B are graphs illustrating gradient descents associated with objective function ƒ_{β}(I). In particular, FIGS. 11A and 11B illustrate gradient descents respectively performed on the sub-simplex of melonic graphs or the sub-simplex of “tadpole” graphs, from 30 different initializations of coefficients αⱼ. Gradient descent enables to optimize the values of the coefficients, that is, to find a combination minimizing the value of the objective function, for a fixed set of graphs. In the rest of the disclosure, the term minimizing the objective function means selecting the combination of values of the coefficient for which, for all the other numerically-tested combinations, the value of the objective function is greater than that associated with the minimizing combination. In certain cases, at least one coefficient is determined as being zero. FIGS. 11A and 11B illustrate the variation of values ƒ_{β}(I), for each initialization, after a plurality of gradient descent steps. Whatever the initialization, FIGS. 11A and 11B show that there exists a combination of invariants for which the value of function ƒ_{β}(I) is minimum. The combinations of invariants resulting from the gradient descent process thus enable to have a distribution associated with pure noise which is as far away as possible from the distributions associated with a non-zero signal-to-noise ratio.

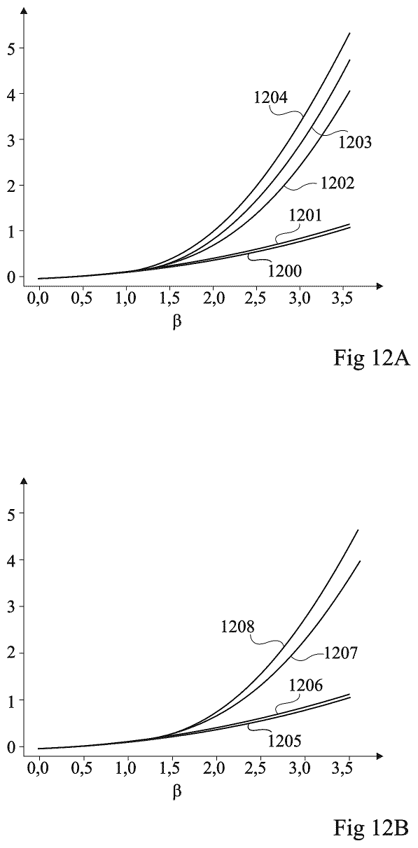

FIGS. 12A and 12B are graphs illustrating the values of the objective function for different graphs and as a function of the value of the signal-to-noise ratio.

In particular, FIG. 12A shows curves 1200, 1201, 1202, and 1203 respectively representing the value of ƒ_{β}(I) as a function of β, for an invariant I being a combination of “tadpole”, melonic, “pillow”, and tetrahedral trace invariants. Curve 1204 represents value ƒ_{β}(I) as a function of β, for an invariant I being a combination of trace invariants belonging to a plurality of categories. In particular, the considered combinations of invariants are obtained as a result of the performing of a gradient descent, in order to determine values of coefficients for which the value of the objective function is minimum.

FIG. 12B shows curves 1205, 1206, 1207, and 1208, similar to curves 1200, 1201, 1202, and 1203, except that the coefficients of the invariants are equal to the inverse of the variance of the associated invariant. As described in relation with FIGS. 8A, 8B, 9A, 9B, and 10A, 10B, the inverse of the variance of a tetrahedral invariant is proportional to the weight of the graph.

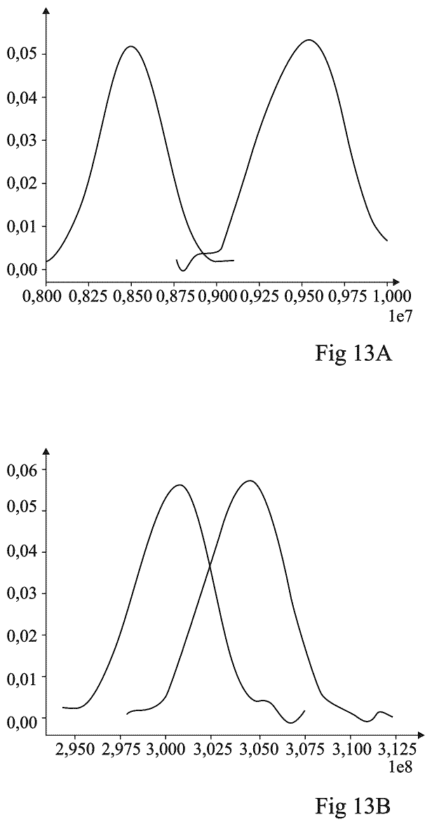

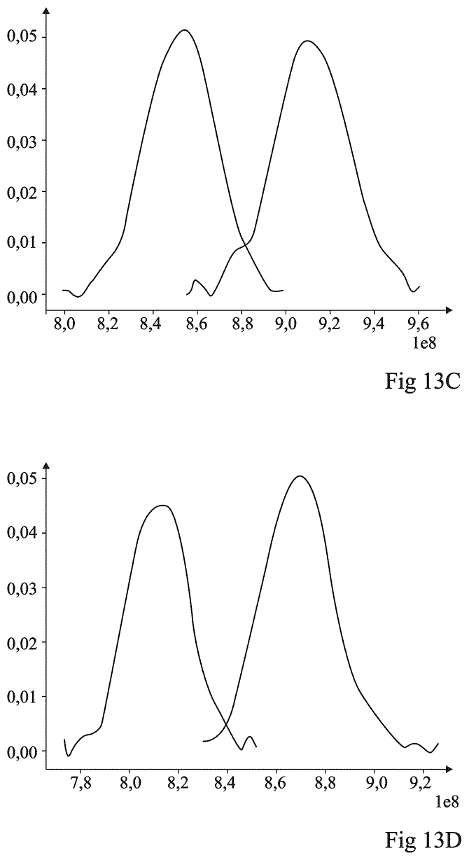

FIGS. 13A, 13B, 13C, and 13D are graphs illustrating trace invariant distributions. In particular, in each FIG. 13A to 13D, the distribution on the left-hand side is a distribution of an invariance value for a pure noise tensor and the distribution on the right-hand side is associated with a tensor comprising a useful signal having a signal-to-noise ratio equal to 3. In addition, the dimension of the tensors used to produce the graphs is equal to 100.

The distributions illustrated in FIG. 13A are those associated with a combination of “pillow”-type trace invariants only, each invariant being weighted by the inverse of its variance. The distributions shown in FIG. 13B are those associated with the same combination of invariants, but weighted by the associated symmetrization weights. The overlap interval between the two distributions is smaller when the invariants are weighted by the inverse of the variance. Indeed, in the case of “pillow”-type invariants, as described in relation with FIG. 10B, the inverse of the variance is not equivalent to the symmetrization weight.

The distributions illustrated in FIG. 13C are those associated with a combination of only tetrahedral trace invariants, each invariant being weighted by the inverse of its variance or by the associated symmetrization weight.

The distributions illustrated in FIG. 13D are those associated with a combination of melonic, “pillow”, “tadpole”, and tetrahedral trace invariants, each invariant being weighted by a value determined as a result of a gradient descent. As an example, “pillow”-type invariants are weighted by the inverse of their variance and invariants of tetrahedral, “tadpole”, or melonic type are weighted by the associated symmetrization weight.

The overlap interval is smaller when the invariance value is computed from a combination of invariants of all types.

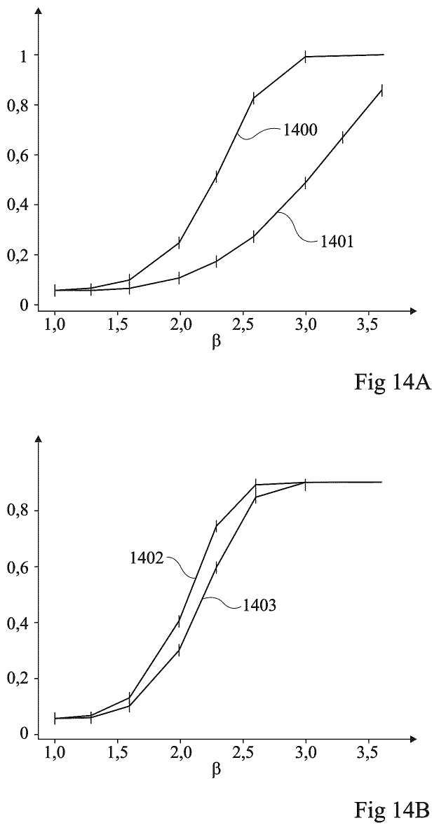

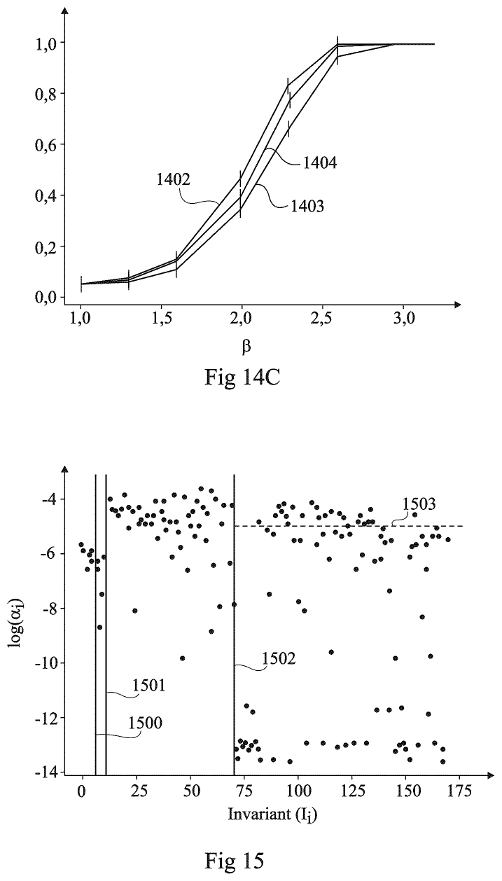

FIGS. 14A, 14B, and 14C are graphs illustrating success rates in signal detection, according to an embodiment of the present disclosure.

FIG. 14A illustrates success rates in the application of the signal detection method such as described in relation with FIG. 6 when the invariance value is a combination of “pillow”-type invariants. In particular, a curve 1400 illustrates the success rate when the “pillow”-type invariant combination is weighted by the inverse of the variance. A curve 1401 illustrates the success rate when the “pillow”-type invariant combination is weighted by the symmetrization weights. As an example, the weights and invariants used are the same as those used to obtain the distributions illustrated in FIGS. 13A and 13B. The success rate is thus better when the weighting is carried out by the inverses of the variance, as suggested in FIGS. 13A and 13B.

FIG. 14B illustrates success rates in the application of the signal detection process such as described in relation to FIG. 6. In particular, a curve 1402 illustrates the success rate for a combination of invariants of all types and a curve 1403 illustrates the success rate for a combination comprising only tetrahedral-type invariants. As an example, the weights and invariants used are the same as those used to obtain the distributions illustrated in FIGS. 13C and 13D. The success rate is thus better when the invariance value is computed from a plurality of types of trace invariants, as suggested in FIGS. 13C and 13D.

FIG. 14C gathers curves 1402 and 1403 with a curve 1404 illustrating success rates for an invariance value being a combination of 28 “pillow”-type invariants, 3 of which are weighted by the associated symmetrization weight and the other 25 by the inverse of their variance.

As an example, the success rates have been computed based on a large number of samples, for example between 500 and 2,000, of tensors having a known signal-to-noise ratio. The method described in relation with FIG. 6 is for example carried out on each sample. The result provided by processor 108 is then compared with reality. It can be seen that the higher the signal-to-noise ratio, the higher the success rate. In particular, the success rate is equal to 1 when the signal-to-noise ratio is greater than 3.

FIG. 15 is a graph illustrating weights obtained by gradient descent. In particular, FIG. 15 illustrates 4 categories of invariants, each separated by vertical lines 1500, 1501, and 1502. To the right of line 1502, points associated with “pillow”-type trace invariants have as an ordinate (log (at)) the logarithm of the weighting value obtained by a gradient descent method. A horizontal line 1503 divides the “pillow”-type invariants into two parts. Above line 1503 are invariants enabling to obtain a satisfactory success rate, for example the success rates illustrated by curve 1404. Below line 1503 are invariants which do not provide satisfactory results. To the left of line 1500, points associated with melonic trace invariants are shown. Between lines 1500 and 1501, points associated with “tadpole” trace invariants are shown. Between lines 1501 and 1502, points associated with tetrahedral trace invariants are shown.

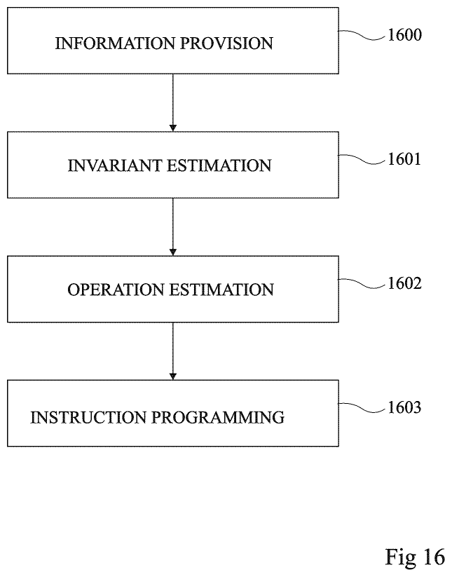

FIG. 16 is a flowchart illustrating a method of selection of a set of trace invariants, according to an embodiment of the present disclosure.

As an example, the method described in relation with FIG. 16 is carried out by a device external to device 100, such as a computer. AS an example, the external device comprises a non-volatile memory in which are stored indications of resources, such as memory and/or time resources, required for the computing of trace invariants and/or of combinations of trace invariants. As an example, the memory stores a list indexing a plurality of combinations of invariants associated with weights determined, for example, by a gradient descent method. In another example, for each invariant in a combination, the associated weight is the symmetrization weight, or the inverse of the variance. As an example, in association with each combination, the memory further stores an indication of a number of operations enabling to compute the associated invariance value. As an example, in association with each combination, the memory further stores an indication of the resources required and/or of the time required to compute the associated invariance value. As an example, the time indication is of the form “small”, “medium”, or “large” associated with, for example, a memory capacity range.

At a step 1600 (INFORMATION PROVISION), information relative to device 100 is provided to the external device. The information includes, for example, the memory resource of device 100. As an example, the memory resource corresponds to the capacity of volatile memory 106. The information further comprises, for example, the performance of processor 108. The information comprises, for example, the order of the tensors acquired by sensor 102 as well as the dimensions of the tensors. As an example, the information further comprises an indication of the time, for example in the form “short”, “medium”, or “long”, within which the computing of the invariance value, or the signal detection method such as described in relation with FIG. 6, is to be performed. In an example, only the capacity of memory 106 as well as a number of operations are supplied to the external device. The number of operations corresponds, for example, to a maximum number of operations for the calculation of the trace invariant in order to satisfy, for example, a computing time constraint.

At a step 1601 (INVARIANT ESTIMATION), the external device estimates a combination of invariants adapted to device 100. As an example, the estimate is made by reading of the list stored in the non-volatile memory. The retained combination of invariants is, for example, that most closely corresponding to the information delivered during step 1600. In another example, certain criteria, such as memory resources, are prioritized.

At a step 1602 (OPERATION ESTIMATION) a number of operations required for the computing of each of the trace invariants comprised in the combination is estimated. In another example, a number of operations required for the computing of the invariance value, associated with the combination, is estimated at step 1602. As an example, the number of operations is estimated based on the dimensions and on the order of the tensor.

At a step 1603 (INSTRUCTION PROGRAMMING) device 100 is, for example, programmed to implement the method described in relation with FIG. 6 based on the computing of invariance values based on the combination estimated during step 1601. As an example, step 1603 comprises the programming of instructions 1603 so that during their execution, the invariance value, based on the combination estimated at step 1601, is computed. As an example, step 1603 further comprises the computing of reference value I_{ref} and the programming of an instruction, from instructions 112, controlling the comparison of the invariance value with the reference value. Step 1603 further comprises the storage of instructions 112 thus programmed in device 100.

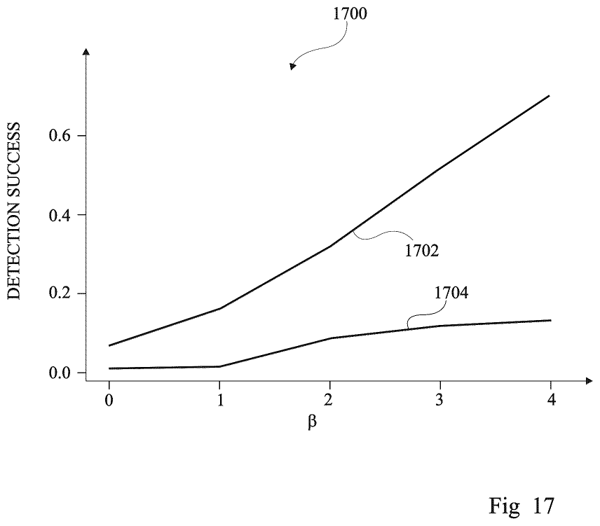

FIG. 17 is a graph 1700 illustrating success rates in signal detection. In particular, curves 1702 and 1704 illustrate success rates, on a scale from 0 to 1, and as a function of the value of signal-to-noise ratio β.

Curve 1702 illustrates the success rates (DETECTION SUCCESS) for the implementation of a signal detection method such as described in relation with FIG. 6 and based on an invariance value comprising tetrahedral-type invariants only. Curve 1704 illustrates the success rates as a result of the implementation of a matrix signal detection method based on the conversion of tensors into matrices. As an example, curves 1702 and 1704 are obtained by processing of the same tensor values. In particular, the tensors used are of order 3 and of dimension 200×200×200, and the success rates are computed based on 1,000 samples. In particular, the implemented matrix method is described in publication “Detection of signal in spiked rectangular models” published in 2021 in “International Conference on Machine Learning” by Jung, Ji Hyung, Hye Won Chung and Ji Oon Lee. Whatever the value of the signal-to-noise ratio, the method described in relation with FIG. 6 achieves a higher success rate than the matrix method.

An advantage of the described embodiments is that they enable to implement a signal detection method on data represented by tensors of orders greater than or equal to 3, without converting them into matrices.

Another advantage of the described embodiments is that they enable to adapt the computing of the invariance value so as to minimize the failure rate in the detection method.

Various embodiments and variants have been described. Those skilled in the art will understand that certain features of these various embodiments and variants could be combined, and other variants will become apparent to those skilled in the art. The estimation of a combination of invariants enabling to compute the invariance value may be based on criteria other than memory resource and/or time criteria.

Finally, the practical implementation of the described embodiments and variants is within the abilities of those skilled in the art, based on the functional indications given hereabove.

1. Method of detecting a useful signal, the method comprising:
the acquisition of a raw signal, by a sensor;
the delivery of the raw signal, to a processing device, the raw signal being represented by a tensor of order d greater than or equal to 3;
the computing, by the processing device, of an invariance value (I) associated with the tensor, the invariance value being computed based on at least one trace invariant under the orthogonal group of degree d(O(n)^{d}) for tensors of order d;
the comparison, by the processing device, of the invariance value associated with the tensor with a first reference value (I_{ref});
based on the comparison, the provision, by the processing device, of an estimate of the signal-to-noise ratio (β) of the raw signal; and
if the estimated signal-to-noise ratio is different from 0, the delivery of the tensor to a circuit configured to process the raw signal.

2. Method according to claim 1, wherein the sensor is configured to acquire image representations and the circuit configured to process the raw signal is an image processing circuit.

3. Method according to claim 1, wherein the invariance value associated with the tensor is a linear combination of a plurality of trace invariants Iⱼ for the orthogonal group (O(n)) for tensors of order d, the combination being in the form ΣⱼαⱼIⱼ, where values αⱼ are weighting coefficients.

4. Method according to claim 3, wherein the linear combination comprises melonic and/or “tadpole”-type and/or tetrahedral and/or “pillow”-type trace invariants.

5. Method according to claim 4, wherein the weighting coefficient of a “pillow”-type trace invariant is equal to the inverse of the variance of the invariant for a pure noise tensor.

6. Method according to claim 4, wherein the weighting coefficient of a melonic and/or “tadpole”-type and/or tetrahedral trace invariant is equal to the symmetrization weight of the invariant.

7. Method according to claim 1, wherein the first reference value is a function of the expectation of the invariance value for a pure noise tensor.

8. Method according to claim 7, wherein the first reference value is equal to E[I]+2\sqrt{Var(I)}, where E[I] and Var(I) are respectively the expectation and the variance of the invariance value for a pure noise tensor.

9. Method according to claim 1, wherein, if the invariance value is greater than the first reference value, the processing device is configured to estimate that the value of the signal-to-noise ratio (β) of the raw signal is strictly greater than 0.

10. Method according to claim 1, further comprising, when it is determined that the invariance value is greater than the first reference value:
the comparison of the invariance value with a second reference value depending on the expectation of the invariance value for a tensor associated with a signal-to-noise ratio of value β.

11. Device comprising:
a sensor configured to acquire a raw signal;
a processing device configured to execute instructions stored in a non-volatile memory of the device, the execution of the instructions enabling to detect whether the raw signal comprises a useful signal, by achieving:
the shaping the raw signal in the form of a tensor of order greater than 3;
the computing of an invariance value of the tensor;
the comparison of the invariance value with a reference value;
based on the comparison, the estimation of the signal-to-noise ratio present in the raw signal; and
if it is determined that the signal-to-noise ratio is non-zero, the delivery of the tensor to a circuit configured to perform processing operations on the raw signal.

12. Device according to claim 11, wherein the sensor is configured to acquire image representations and wherein the circuit configured to perform raw signal processing operations is an image processing circuit.

13. Method of determining a combination of trace invariants, the combination being in the form ΣⱼαⱼIⱼ, where the Iⱼ are trace invariants and values αⱼ are weighting coefficients, adapted to a device, the method comprising:
the delivery of the indication of the memory resources of the device to an external device;
the delivery of the indication of a processing time, to the external device;
the delivery of an indication of dimensions of the order of tensors to the external device;
the search for a set of trace invariants, in association with a set of weights, forming the combination, among a plurality of trace invariants, each set of trace invariants being associated with a cost and each cost value being stored in a memory of the external device in association with an identifier of the associated set, the search for the set of invariants being carried out based on the memory resources and/or on the computing time and/or on the indication of the provided dimensions;
the delivery of the set of trace invariants and of the weights to the device so that an invariance value can be computed, by the device, based on the determined combination of invariants.

14. Method according to claim 13, wherein the weights, associated with each trace invariant in each combination, are determined by the performing of a gradient descent on an objective function determining a distance between the distribution of the invariance value associated with the combination for a pure noise tensor and for a tensor having a non-zero signal-to-noise ratio.

15. Method according to claim 13, wherein each trace invariant is a melonic and/or “tadpole”-type and/or tetrahedral and/or “pillow”-type trace invariant.
